(19) United States
(12) Patent Application Publication
(10) Pub. No.: US 2010/0091684 A1
(43) Pub. Date: Apr. 15, 2010

(54) System and Method for Discovery of Dynamically Assigned Information Handling System IP Addresses

(76) Inventors: Robert Lee Winter, Leander, TX (US); Narayanan Subramaniam, Bangalore (IN)

Correspondence Address: HAMILTON & TERRILE, LLP, P.O. BOX 203518, AUSTIN, TX, 78720, US

(21) Appl. No.: 12/249,254

(22) Filed: Oct. 10, 2008

(51) Int. Cl. H04L 12/28

(52) U.S. Cl. 370/254

(57) ABSTRACT

A network manager tracks network nodes in an IPv6 network by identifying server nodes that dynamically-assign network addresses, such as DHCP server nodes, retrieving prefix information from the DHCP server nodes, and querying a range of network addresses determined from application of the prefix information to identify client nodes of each DHCP server node. In one embodiment, the prefix information comprises a start prefix value that identifies the starting address of the range and a prefix length value that determines the number of addresses in the range. For example, the network manager sends echo messages to each address in the range by starting at an address determined from the start prefix value and incrementing the network address for a number of increments equal to at least the prefix length value.

### BACKGROUND OF THE INVENTION

1. Field of the Invention

The present invention relates in general to the field of information handling system networking, and more particularly to a system and method for discovery of dynamically-assigned information handling system IP addresses.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems use by enterprises and individuals continues to grow in large part because of the growing ease with which end users are able to communicate over networks. A prominent example of this is the impact of the Internet on enterprises and individuals. The Internet manages communications between diverse types of information handling systems by using standardized communication techniques. For example, the Internet Protocol (IP) defines standardized addressing techniques that help to insure that each information handling system interfaced with the Internet will have a unique address. IP addresses are also used on intranets for the same purpose, such as enterprise intranets that tie enterprise information handling systems together with a common network. Under Internet Protocol version 4 (IPv4), addresses are 32 bits long. A new Internet Protocol, version 6 (IPv6), has recently been proposed that will increase the number of bits of an Internet address to 128 bits. As with IPv4, IPv6 provides for the use of static and dynamic IP addresses. Static IP addresses are statically assigned to an information handling system when the information handling system interfaces with a network. Dynamic IP addresses are dynamically-assigned using the Dynamic Host Configuration Protocol (DHCP). DHCP allows a server to assign IP addresses to clients dynamically so that any particular client may have its IP address changed at virtually any time. IPv6 also allows dynamic IP address assignments using Router Discovery+Stateless Autoconfiguration, which delegates prefix blocks to IPv6 capable routers so that the routers use the prefixes for on-link address assignment for client nodes.

One difficulty that arises with the use of dynamic IP addresses is tracking the addresses that are dynamically-assigned in a given domain. Under IPv4 with 32 bits, the number of available addresses is small compared to the number of possible addresses with the 128 bits of IPv6. A management node would take a considerable amount of time “pinging” nodes within a domain or subnet of an IPv6 network by using a brute force technique of searching for every possible address. To avoid such an expansive search, a network administrator might instead define a set of IP discovery ranges, such as by specifying the first 64 bits of a search with available prefix values, however, even if a search is limited to the last 64 bits of the addresses, the number of possible addresses is astronomical. One solution is to place an agent on each node to provide address information to a managing node and thus limit the number of pings needed to find the nodes. However, placing an agent on each node within a domain presents difficulties in the distribution of the agent to the nodes, the compatibility of the agent with the nodes and maintaining the agent at the nodes over time. If an agent fails to respond to a management node ping, the management node will not have that node's address for network maintenance, security or other purposes.

### SUMMARY OF THE INVENTION

Therefore, a need has arisen for a system and method that discovers network nodes having dynamically-assigned addresses without using an agent on the discovered nodes.

In accordance with the present invention, a system and method are provided which substantially reduce the disadvantages and problems associated with previous methods and systems for discovery of network nodes. A network manager retrieves prefix information from one or more server nodes that dynamically-assign network addresses and applies the prefix information to determine a range of network addresses associated with the server node. The network manager sends messages to each network address in the range to determine client nodes that have the dynamically-assigned network addresses.

More specifically, a network manager interfaces with an IPv6 network having one or more server nodes that dynamically-assign network addresses. A solicit module of the network manager issues a solicit message to the network to solicit a response from each server node and stores the address of each server node that responds to the solicit message. An inform module of the network manager issues an inform message to each stored server node address to retrieve a start prefix value and prefix length value for each server node. An echo module applies the start prefix value and prefix length value to determine each possible network address associated with the server node and sends a message to each network address to determine if the server node has assigned a client to each address. For example, the echo module applies the start prefix value to a domain value associated with the server to determine a starting dynamic address value. The echo modules sends an echo message to the starting dynamic address value to determine if a client is at that address and then increments the starting address value to the next sequential address value. The echo module continues to send echo messages and to increment the address value until the number of increments is at least equal to a prefix length value that defines the number of address assignable by the server node.

The present invention provides a number of important technical advantages. One example of an important technical advantage is that a management node discovers nodes within a domain having dynamically-assigned addresses without the use of an agent on the discovered nodes, such as nodes that are dynamically-assigned addresses with IPv6 Router Discovery+Stateless Autoconfiguration. Node discovery is accomplished without protocol modifications. The number of addresses that are searched is limited from a starting prefix of a DHCP server to the range specified for the DHCP server, which will typically be smaller than the possible ranges allowed by IPv6. The starting prefix and range are obtained from the DHCP server with standardized commands. Thus, the search time for a complete list of client nodes of the DHCP server will be less than a brute force search would require with the length of the search adjustable by network management that sets a reasonably narrow range of IP addresses for each DHCP server.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 depicts a block diagram of a network manager interfaced with an IPv6 network to determine addresses that are dynamically-assigned by DHCP server information handling system nodes; and

FIGS. 2A and 2B, referred to herein as FIG. 2, depict a flow diagram of a process for determining dynamically-assigned network addresses within an IPv6 network.

### DETAILED DESCRIPTION

A network manager tracks dynamically-assigned network addresses by retrieving prefix information from server information handling systems that dynamically-assign network addresses and applying the prefix information to query client information handling systems to determine which addresses are assigned. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

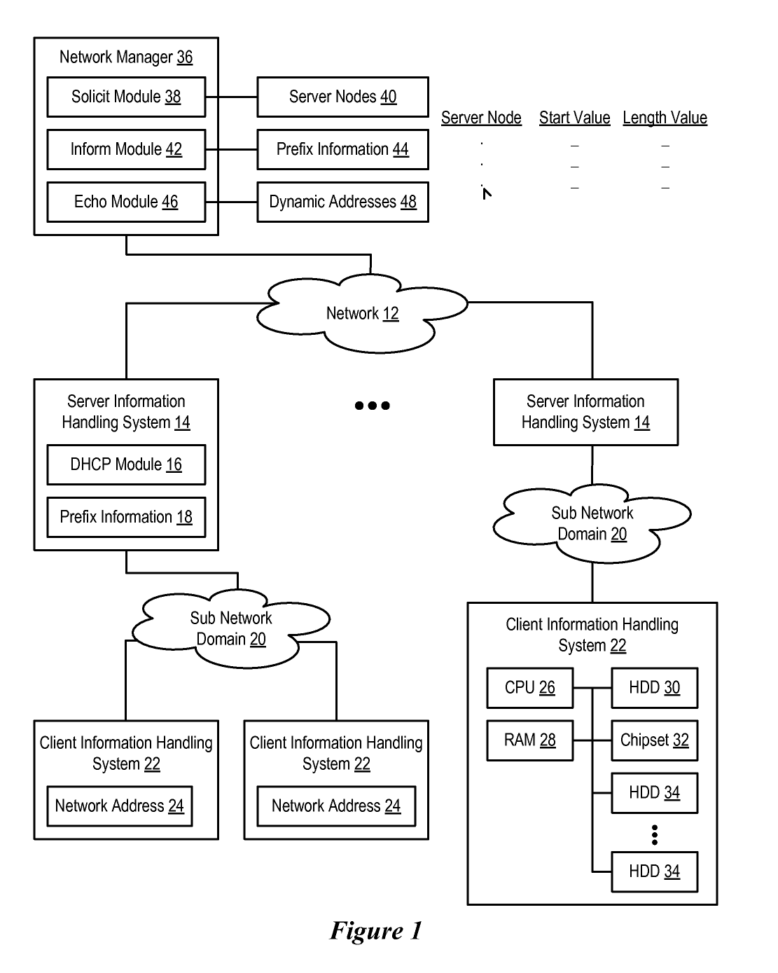

Referring now to FIG. 1, a block diagram depicts a network manager 10 interfaced with an IPv6 network 12 to determine addresses that are dynamically-assigned by DHCP server information handling system nodes 14. Each server information handling system node 10 has a DHCP module 16 that dynamically-assigns network addresses using prefix information 18 to clients within a subnetwork domain 20. Client nodes include client information handling systems 22 which communicate within subnetwork domain 20 and network 12 by reference to one or more dynamically-assigned network addresses 24. As described herein, information handling systems have a plurality of processing components that cooperate to process information, such as a CPU 26, RAM 28, a hard disk drive 30, a chipset 32 and network interface cards (NICs) 34. In the example embodiment, an IPv6 network configuration has a 128 bit address for each node. In alternative embodiments, network communications may be supported with other types of protocols, such as IPv4 32 bit addresses. In the example embodiment, an IPv6 client node 22 is assigned one or more network addresses 24 using DHCP communications. Each server node 14 of network 12 has a range of network addresses available as defined by prefix information 18 which the server node 14 dynamically-assigns to client information handling systems 22 of that server node's subnetwork domain 20.

A network manager 36 interfaces with network 12 to manage network nodes, such as server information handling system nodes 14 and client information handling system nodes 22. Network manager 36 is, for example, a module running on an information handling system that interfaces with network 12. Network manager 36 tracks network nodes by discovering addresses that are dynamically-assigned by server nodes 14. A solicit module 38 initiates discovery of dynamically-assigned network addresses by identifying network addresses for each server node 14 and storing the network addresses in a server nodes database 40. Solicit module 38 identifies server nodes 14 by leveraging IETF RFC 2064 specification's IPv6 multicast addresses:

“FF02::1:2” for addressing all DHCPv6 servers within a local link segment

“FF05:1:3” for addressing all DHCPv6 servers within an enterprise network Solicit module 38 sends an IPv6 multicast packet to these addresses in the form of DHCPv6 SOLICIT messages and caches the reply from each DHCPv6 server in server nodes database 40, such as an internal queue that will allow rapid access to the server node addresses. Although the example embodiment uses a SOLICT message in an IPv6 environment, in other embodiments other types of solicit messages may be used as appropriate for the protocol in use to obtain responses from server nodes 14.

Once replies from server nodes 14 to the SOLICIT message have subsided, an inform module 42 scans the source addresses of each reply stored in server nodes 40 and requests prefix information from each server node 14. For example, inform module 42 sends an INFORM message in turn to each server node 14 that was identified by the SOLICIT messages to request from each server node 14 prefix information configured in each server node 14. In the present embodiment, the INFORM message requests options IA_RANGE_PREFIX and IA_RANGE_PREFIX_LEN as set forth in the following exemplary code:

The Option Request option is used to identify a list of options in a message between a client and a server. The format of the Option Request option is:

0 1 2 3
0 1 2 3 4 5 6 7 8 9 0 1 2 3 4 5 6 7 8 9 0 1 2 3 4 5 6 7 8 9 0 1

| | |
|---|---|
| OPTION_ORO | option-len |
| requested-option- | requested-option- |
| code-1 | code-2 |

. . .

option-code OPTION-ORO (6).
option-len 2 * number of requested options.
requested-option-code-n The option code for an option requested by the client.

The Option Code IA_RANGE_PREFIX denotes that the server node 14 should return the list of IPv6 start addresses that are used by the server node 14 to assign IPv6 addresses. In one embodiment, the first portion of the address assigned by the server node falls within a range reserved for the subnetwork domain 20 associated with the server. In this case, the start address is added to the end of the subnetwork domain address to define the IPv6 address. In alternative embodiments, the start address includes all 128 bits of the IPv6 address. The Option Code IA_RANGE_PREFIX_LEN denotes the length of the IPv6 prefix, such as a value providing the number of possible addresses that are assignable by the server node 14 from the start address value. Inform module 42 stores server node addresses and associated prefix start values and prefix length values in a prefix information database 44.

Once prefix information is gathered, an echo module 46 applies the prefix information to discover client nodes 22 that are using the available dynamic addresses of each server node 14. The IPv6 address is denoted by “DHCPv6S-i” and the start prefix and length “j” for each DHCPv6 server “i” is denoted by “IA RANGE_PREFIX-i-j” and “IA_RANGE_PREFIX_LEN-i-j” respectively. For each DHCP server node 14, the prefix and length values are applied to determine the dynamically-assignable addresses that are possible by the associated server node by sequentially incrementing the start prefix value IA_RANGE_PREFIX-i-j for a number of times as indicated by the length value IA_RANGE_PREFIX_LEN-i-j. The candidate IPv6 address potentially served by the DHCPv6 server node 14 “DHCPv6S-i” is denoted as “IPv6-i-k.” For each determined possible address assignable by the server node 14, echo module 46 determines if a client node has the address by sending an IPv6 ECHO command and storing the response in dynamic addresses database 48 if a response is received in a predetermined time. For instance, upon receiving an IPv6 ECHO REPLY, the associated address “IPv6-i-k” is designated within the discovered address range as assigned with “V6DR-i.” The ECHO is sent for each possible dynamically-assignable address of each server node recursively so that an exhaustive search is performed for responsive client nodes 22 of each server node 14 within the range of addresses provided by the server nodes 14. The performance of the recursive search will depend upon the size of the range of dynamically-assignable addresses defined for each server node. In alternative embodiments, other types of echo commands may be sent to each candidate address to determine if a node at that address responds to the command.

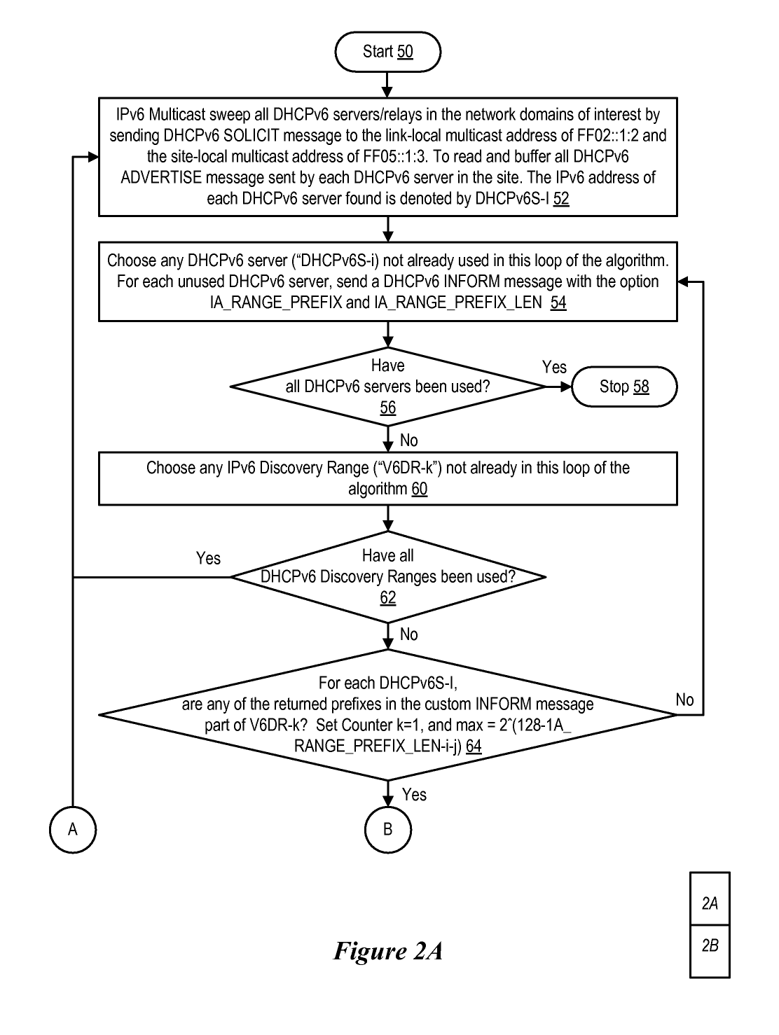

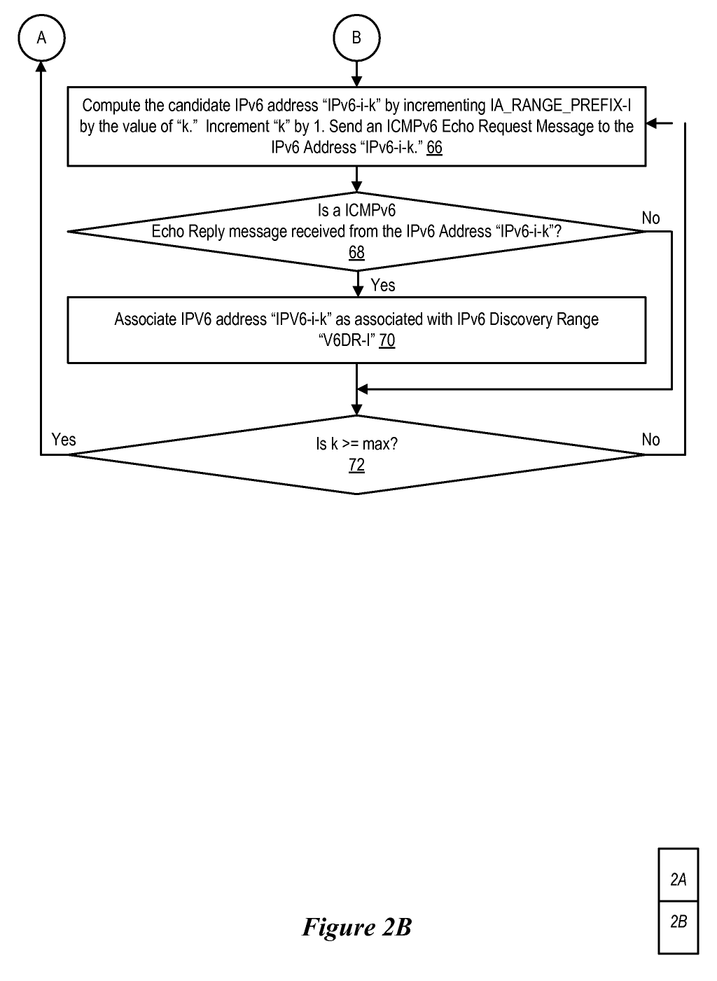

Referring now to FIG. 2, a flow diagram depicts a process for determining dynamically-assigned network addresses within an IPv6 network. The process starts at step 50 and continues to step 52 to solicit a response from each DHCP server of the network. For example, at step 52 an IPv6 multicast sweeps all DHCPv6 servers/relays in the domains of interest by sending a DHCPv6 SOLICIT message to the link-local multicast address of FF02::1:2 and the site local multicast address of FF05::1:3. The network manager buffers all DHCPv6 ADVERTISE messages sent by each DHCP server and denotes each identified DHCPv6 server node by DHCPv6S-i. At step 54, each DHCPv6 server identified by the solicit messages is selected in turn and sent a DHCPv6 INFORM message with option IA_RANGE_PREFIX and IA_RANGE_PREFIX_LEN to determine a prefix start value and prefix length value for each server. At step 56, a determination of whether each identified server has been used is determined, and if so, the process ends at step 58. If an identified DHCP server has not been used, the process continues to step 60 to choose any IPv6 discovery range “V6DR-k” not already used.

At step 62 a determination is made of whether all IPv6 discovery ranges provided from the INFORM message for the server node at hand have been used and, if so, the process returns to step 54. If a discovery range for a server node has not been used, the process continues to step 64 where, for each DHCPv6S-I a determination is made of whether any of the returned prefix values from the INFORM message are within V6DR-k. If not, the process returns to step 60. If so, a counter is set of k=1 and max=2̂(128-IA_RANGE_PREFIX_LEN-i-j). At step 66, the possible IPv6 address IPv6-i-k is determined by incrementing IA_RANGE_PREFIX-I by the value of k, such as a value of 1 where every address in the range is a possible address. An ICMPv6 ECHO request message is sent to the address IPv6-i-k. At step 68, a determination is made of whether an ECHO reply message is received in response to the ECHO request message to the address IPv6-i-k. If an echo reply is received, the process continues to step 70 to associate the address IPv6-i-k as an assigned address within discovery range V6DR-i. Once the address is identified as an assigned address, the process continues to step 72. If no echo reply is received at step 68, the process continues to step 72 without identifying the address as an assigned address. At step 72, a determination is made of whether k has reached the maximum value as set from the prefix length value. If k has not reached the maximum value, the process returns to step 68 to increment to the next address for the server node of interest and so forth recursively until the maximum value is reached. If k has reached the maximum value, the process returns to step 54 to proceed through another set of possible addresses and so forth recursively until all possible address ranges of all server nodes have been searched to find all dynamically-assigned addresses.

Although the present invention has been described in detail, it should be understood that various changes, substitutions, and alterations can be made hereto without departing from the spirit and scope of the invention as defined by the appended claims.

What is claimed is:

1. An information handling system comprising:
processing components operable to process information;
one or more network interfaces operable to interface with one or more networks;
a network manager running on one or more of the processing components, the network manager operable to communicate through the network interfaces by sending a first command to identify one or more server nodes on the network that dynamically-assign address information to one or more client nodes, a second command to identify prefix information from the server nodes, and a third command using the prefix information to identify client nodes associated with the server nodes.

2. The information handling system of claim 1 wherein the prefix information comprises a start prefix value and prefix length value for each server node and the third command comprises an echo message to each address from an address based on the start prefix value through an address based on the prefix length value.

3. The information handling system of claim 2 wherein the third command further comprises an incremental increase of the address from the address start prefix value for a number of increments of the prefix length value.

4. The information handling system of claim 1 wherein the first command comprises a solicit message for locating each server node, the network manager further operable store server node responses to the solicit message.

5. The information handling system of claim 1 wherein the second command comprises an inform message sent to each server node.

6. The information handling system of claim 5 wherein the inform message requests a start prefix value from which the server dynamically provides addresses to client nodes and a length prefix value of the number of prefix increments allowed to the server for dynamically providing addresses to client nodes.

7. The information handling system of claim 6 wherein the network manager uses the prefix information to identify client nodes by computing possible client node addresses by adding the prefix start value and a predetermined domain address associated with the server.

8. The information handling system of claim 7 wherein the network comprises an IPv6 network.

9. A method for discovery of dynamically-assigned network addresses within a network domain having at least one server node that dynamically-assigns network addresses, the method comprising:
retrieving prefix information from the at least one server node;
applying the prefix information to determine a range of network addresses dynamically-assignable by the server node, the range of network addresses smaller than and within a range of network addresses associated with the network domain; and
determining the dynamically-assigned network addresses by attempting communication with each network address in the range of network addresses dynamically-assignable by the server node.

10. The method of claim 9 further comprising identifying plural server nodes in the network domain that dynamically-assign network addresses and wherein retrieving prefix information further comprises retrieving prefix information from each of the plural server nodes in the network domain that dynamically-assign network addresses.

11. The method of claim 10 wherein identifying plural server nodes comprises sending a solicit message to the network domain.

12. The method of claim 9 wherein retrieving prefix information further comprises retrieving a start prefix value and a prefix length value.

13. The method of claim 12 wherein retrieving prefix information further comprises sending an inform message to each of the at least one server node.

14. The method of claim 12 wherein determining the dynamically-assigned network addresses further comprises:
sending an echo message to an address determined from the start prefix value;
incrementally increasing the address;
sending an echo message to the incrementally increased address; and
repeating the incrementally increasing and sending and echo message to the incrementally increased address for at least the prefix length value.

15. The method of claim 14 wherein the network comprises an IPv6 compliant network.

16. A system for discovery of dynamically-assigned network addresses, the system comprising:
a solicit module operable to identify server nodes that dynamically-assign network addresses;
an inform module operable to retrieve prefix information from each identified server node; and
an echo module operable to apply the prefix information to identify dynamically-assigned network addresses made by each identified server.

17. The system of claim 16 wherein the prefix information comprises a start prefix value and a prefix length.

18. The system of claim 17 wherein the echo module applies the prefix information by incrementally sending echo messages from an address computed with the start prefix value for a number of increments computed with the prefix length.

19. The system of claim 18 wherein the inform module retrieves prefix information by sending an inform message to each server node identified by the solicit module.

20. The system of claim 19 wherein the dynamically-assigned network addresses comprise IPv6 addresses.
